(19) United States
(12) Patent Application Publication
(10) Pub. No.: US 2026/0298446 A1
(43) Pub. Date: Oct. 1, 2026

(54) LIGHTING DEVICE

(71) Applicant: KOITO MANUFACTURING CO., LTD., Tokyo (JP)

(72) Inventors: Kazuyoshi NAKAMURA, Shizuoka (JP); Tomoya HOSOZAWA, Shizuoka (JP); Shota YONEMARU, Shizuoka (JP)

(21) Appl. No.: 19/571,531

(22) Filed: Mar. 19, 2026

(30) Foreign Application Priority Data
Mar. 28, 2025 (JP) 2025-056287

(51) Int. Cl. F21V 17/00; F21V 5/00; F21V 29/76; F21V 31/03; F21Y 115/10

(52) U.S. Cl. CPC F21V 17/005; F21V 5/007; F21V 29/763; F21V 31/03; F21Y 2115/10

(57) ABSTRACT

A lighting device includes: a plurality of light sources; a plurality of lenses t each controls light emitted from a corresponding one of the plurality of light sources; and a lens holder that holds the plurality of lenses. Each of the plurality of lenses includes a flange portion. The lens holder includes a first lens holder member having a plurality of lens insertion holes into which the plurality of lenses are inserted, respectively, and a second lens holder member having a plurality of openings through which the light emitted from the plurality of lenses passes, respectively. The flange portion of each of the plurality of lenses is sandwiched between the first lens holder member and the second lens holder member, thereby holding the plurality of lenses in the lens holder.

### CROSS-REFERENCE TO RELATED APPLICATIONS

This application is based on and claims priority from Japanese Patent Application No. 2025-056287, filed on Mar. 28, 2025, with the Japan Patent Office, the disclosure of which is incorporated herein in its entirety by reference.

### TECHNICAL FIELD

The present disclosure relates to a lighting device.

### BACKGROUND

A lighting device has been known, which includes a plurality of light sources and a plurality of lenses for controlling the light emitted from the light sources (see, e.g., Japanese Patent Laid-Open Publication No. 2020-017457).

### SUMMARY

In the above-described lighting device, it is desirable that the work of assembling the plurality of lenses be easy.

The present disclosure has been made in view of such circumstances, and an object thereof is to provide a lighting device in which assembly of a plurality of lenses is easy.

To address the above object, according to an embodiment of the present disclosure, a lighting device includes: a plurality of light sources; a plurality of lenses that each controls the light emitted from a corresponding one of the plurality of light sources; and a lens holder that holds the plurality of lenses. Each of the plurality of lenses include a flange portion. The lens holder includes a first lens holder member having a plurality of lens insertion holes into which the plurality of lenses are inserted, respectively, and a second lens holder member having a plurality of openings through which light emitted from the plurality of lenses passes, respectively. The flange portion of each of the plurality of lenses is sandwiched between the first lens holder member and the second lens holder member, thereby holding the plurality of lenses in the lens holder.

According to the present disclosure, it is possible to provide a lighting device in which assembly of a plurality of lenses is easy.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic perspective view of a lighting device according to an embodiment.

FIG. 2 is a perspective view of the lighting device disassembled into a lens assembly and a heat sink assembly, as viewed from the front.

FIG. 3 is a perspective view of the lighting device disassembled into the lens assembly and the heat sink assembly, as viewed from the rear.

FIG. 4 is an exploded perspective view of the lens assembly.

FIG. 5 is a cross-sectional view illustrating a lens held by a lens holder.

### DETAILED DESCRIPTION

In the following detailed description, reference is made to the accompanying drawings which form a part hereof. The illustrative embodiments described in the detailed description, drawings, and claims are not meant to be limiting. Other embodiments may be utilized, and other changes may be made without departing from the spirit or scope of the subject matter presented herein.

Hereinafter, the present disclosure will be described with reference to the drawings based on the embodiments. The configurations described herein below are illustrative only for facilitating the understanding of the present disclosure, and the scope of the present disclosure should be defined only by the appended claims. The same or equivalent components and members illustrated in the respective drawings will be denoted by the same reference numerals, and redundant descriptions thereof will be omitted as appropriate. Further, the dimensions of the members in the respective drawings are enlarged or reduced as appropriate for ease of understanding. Further, some members that are not important for describing the embodiments are omitted in the respective drawings.

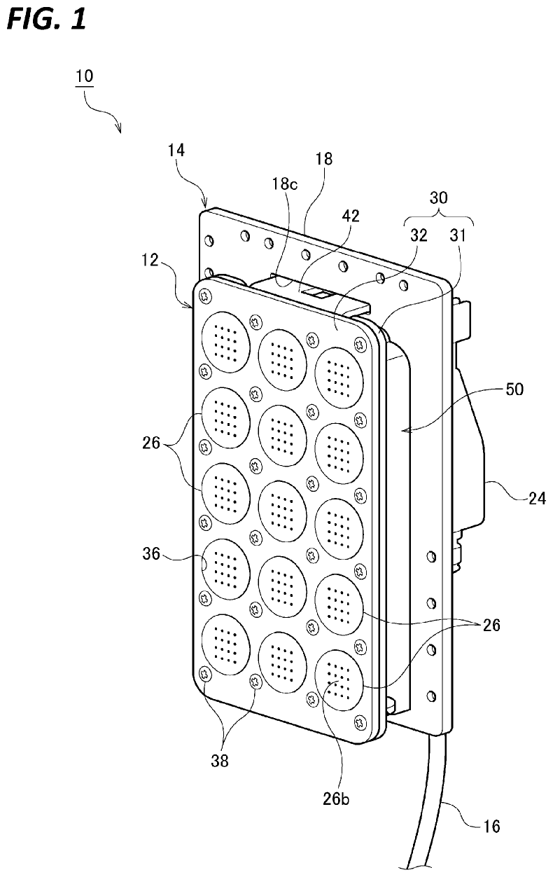

FIG. 1 is a schematic perspective view of a lighting device 10 according to an embodiment. The lighting device 10 illustrated in FIG. 1 is a lighting device used as an aircraft landing light. The lighting device 10 includes a lens assembly 12, a heat sink assembly 14, and a power feed cable 16.

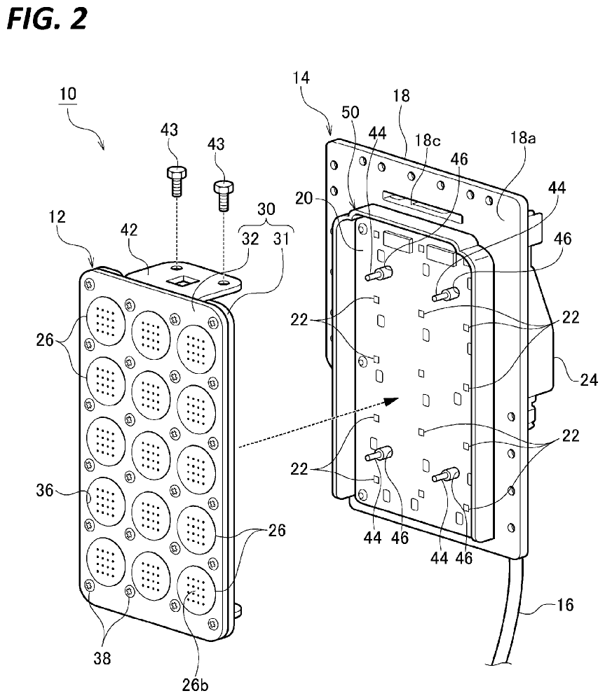

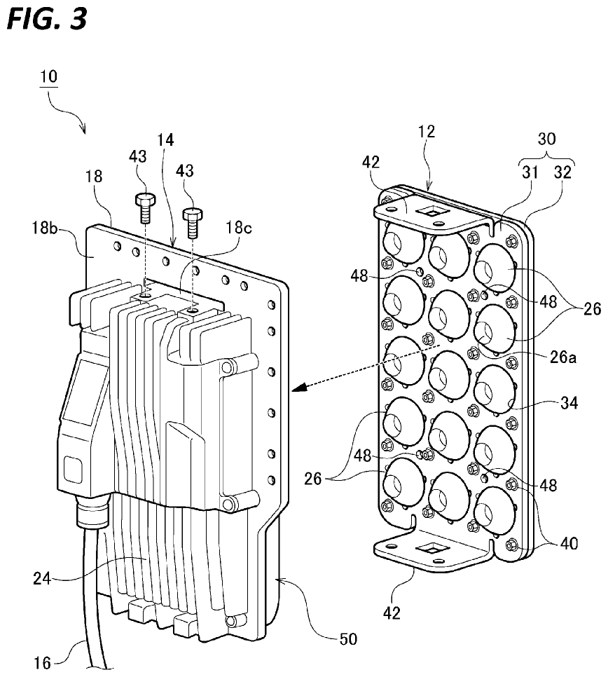

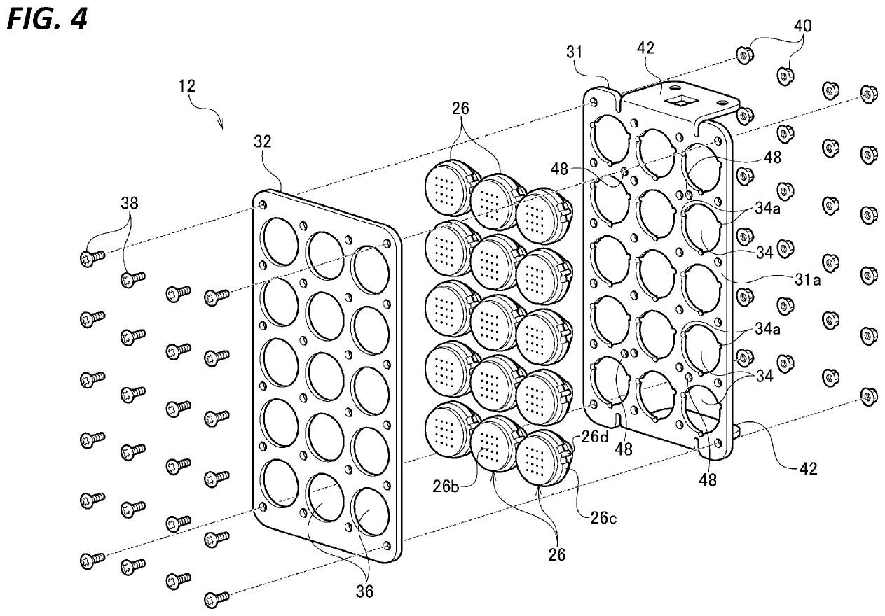

FIG. 2 is a perspective view of the lighting device 10 disassembled into the lens assembly 12 and the heat sink assembly 14, as viewed from the front. FIG. 3 is a perspective view of the lighting device 10 disassembled into the lens assembly 12 and the heat sink assembly 14, as viewed from the rear. FIG. 4 is an exploded perspective view of the lens assembly 12.

The heat sink assembly 14 includes a heat sink 18, a substrate 20 supported on a front surface 18a of the heat sink 18, and a plurality of light sources 22 mounted on the substrate 20. The light sources 22 may be LEDs. The plurality of light sources 22 are arranged in an array form. An electric current is supplied to the substrate 20 through the power feed cable 16, and the light sources 22 emit light by the supply of the electric current from the substrate 20. The heat sink 18 dissipates heat generated from the light sources 22. Heat dissipation fins 24 are provided on a rear surface 18b of the heat sink 18.

The lens assembly 12 includes a plurality of lenses 26 and a lens holder 30 that holds the plurality of lenses 26. One lens 26 corresponds to one light source 22. The lens holder 30 holds the plurality of lenses 26 in an array form corresponding to the array of the light sources 22. Each lens 26 is disposed in a light emission direction (on the optical axis) of a corresponding one of the light sources 22, and is configured to receive light from the light source 22 at an incident surface 26a, to perform a predetermined optical control such as deflection and diffusion, and to emit the light forward of the lighting device from an exit surface 26b.

Each lens 26 has a flange portion 26c. The flange portion 26c is formed to protrude outward from the side surface of the lens 26 between the incident surface 26a and the exit surface 26b. The flange portion 26c has a substantially circular shape in a front view.

The lens holder 30 includes a first lens holder member 31 and a second lens holder member 32. The first lens holder member 31 is a plate-shaped body with a plurality of lens insertion holes 34 into which the respective lenses 26 are inserted. The plurality of lens insertion holes 34 are arranged in an array form corresponding to the array of the lenses 26. In each lens insertion hole 34, a portion of the lens 26 on the side of the incident surface 26a relative to the flange portion 26c is inserted. Each lens insertion hole 34 has a substantially circular shape in a front view. An inner diameter of the lens insertion hole 34 is smaller than an outer diameter of the flange portion 26c. In a state where a portion of the lens 26 is inserted into the lens insertion hole 34, the flange portion 26c is supported on the peripheral edge of the lens insertion hole 34 in a front surface 31a of the first lens holder member 31.

The second lens holder member 32 is a plate-shaped body with a plurality of openings 36 through which light emitted from the respective lenses 26 passes. The plurality of openings 36 are arranged in an array form corresponding to the array of the lenses 26. Each opening 36 is formed to expose the exit surface 26b of a corresponding of the lenses 26. Each opening 26c has a substantially circular shape in a front view. An inner diameter of the opening 36 is smaller than the outer diameter of the flange portion 26c.

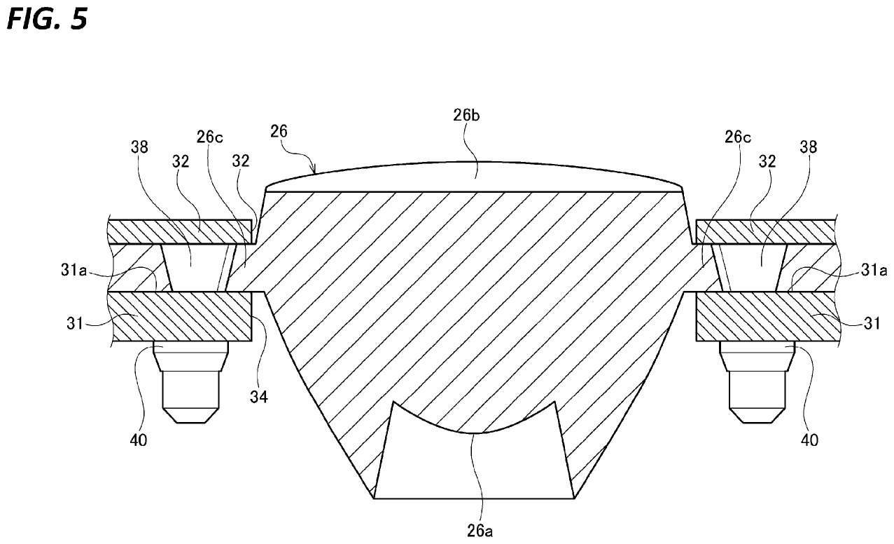

FIG. 5 is a cross-sectional view illustrating the lens 26 held by the lens holder 30. As described above, a portion of the lens 26 on the side of the incident surface 26a relative to the flange portion 26c is inserted into the lens insertion hole 34 of the first lens holder member 31. Since the outer diameter of the flange portion 26c is larger than the inner diameter of the lens insertion hole 34, the flange portion 26c is supported on the peripheral edge of the lens insertion hole 34 in the front surface 31a of the first lens holder member 31.

In a state where the plurality of lenses 26 are inserted into the respective corresponding lens insertion holes 34 of the first lens holder member 31, the second lens holder member 32 is overlaid on the first lens holder member 31, and the first lens holder member 31 and the second lens holder member 32 are fastened using a plurality of bolts 38 and nuts 40. Thereby, the flange portion 26c of each lens 26 is sandwiched between the first lens holder member 31 and the second lens holder member 32, and the plurality of lenses 26 are held by the lens holder 30. That is, by fastening the first lens holder member 31 and the second lens holder member 32 with the plurality of bolts 38 and nuts 40, the plurality of lenses 26 are jointly fastened.

In this way, in the lighting device 10 according to the present embodiment, the plurality of lenses 26 may be collectively and easily assembled by inserting the lenses 26 into the respective lens insertion holes 34 of the first lens holder member 31 and overlaying and fastening the first lens holder member 31 and the second lens holder member 32.

In the present embodiment, each lens 26 is formed with a plurality of protrusions 26d. Further, a plurality of recesses 34a corresponding to the protrusions 26d are formed at the edges of the respective lens insertion holes 34 of the first lens holder member 31. When each lens 26 is inserted into the lens insertion hole 34, the respective protrusions 26d are fitted into the corresponding recesses 34a. By the fitting of the protrusions 26d into the recesses 34a, rotation of the respective lenses 26 with respect to the first lens holder member 31 is prevented.

When an orientation in which the lenses 26 are to be arranged is predetermined, the positions at which the protrusions 26d and the recesses 34a are formed may be adjusted in order to prevent erroneous assembly of the lenses 26. That is, the protrusions 26d and the recesses 34a may be formed such that all of the protrusions 26d are fitted into the recesses 34a only when the lenses 26 are arranged in one predetermined orientation.

The first lens holder member 31 is provided with a support 42, which is formed by bending a portion of the plate-shaped body by 90 degrees. By inserting the support 42 into an elongated hole 18c provided in the heat sink assembly 14 and fastening the support 42 with a bolt 43, the lens assembly 12 is attached to the heat sink assembly 14, and each lens 26 is supported on the optical axis of the corresponding light source 22.

As illustrated in FIG. 2, a plurality of positioning pins 44 protrudes from the front surface 18a of the heat sink 18. The substrate 20 is provided with a plurality of through holes 46 through which the respective positioning pins 44 are inserted. Further, the first lens holder member 31 is also provided with a plurality of through holes 48 through which the respective positioning pins 44 are inserted. By inserting the respective positioning pins 44 through the corresponding through holes 46 and 48, optical axis alignment between the respective light sources 22 mounted on the substrate 20 and the corresponding lenses 26 may be achieved. Since a fine positional alignment between the light sources 22 and the lenses 26 is unnecessary, the assembly efficiency of the lighting device 10 may be improved.

As illustrated in FIG. 2, a standing wall 50 is provided on the front surface 18a of the heat sink 18 so as to surround a part of the outer periphery of the substrate 20. In the present embodiment, when the lighting device 10 is arranged such that the front-rear direction thereof extends in the horizontal direction, the standing wall 50 is provided so as to surround the upper side and both the left and right sides of the outer periphery of the substrate 20, and no standing wall is provided on the lower side of the outer periphery of the substrate 20. Further, the standing wall 50 is formed to have a height such that at least a portion thereof comes into contact with the first lens holder member 31.

An internal space that is open only at the lower side thereof is formed by the standing wall 50 provided on the heat sink 18 and the lens holder 30, and the light sources 22 mounted on the substrate 20 and the incident surfaces 26a of the lenses 26 are disposed in the internal space. With such a configuration, an entry of water or a solvent into the internal space is prevented or at least minimized, so that the electrical and optical reliability of the lighting device 10 may be improved. Further, since the lower side of the internal space is open, even when water or a solvent enters the internal space, the water or solvent may be discharged to the outside.

Further, in the present embodiment, at least a portion of the standing wall 50 comes into contact with the first lens holder member 31, thereby defining a distance between the light source 22 and the incident surface of the lens 26. Since the distance between the light source 22 and the incident surface of the lens 26 is defined by the standing wall 50, fine positional alignment in the height direction between the light source 22 and the lens 26 becomes unnecessary, so that the assembly efficiency of the lighting device 10 may be improved.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A lighting device comprising:
a plurality of light sources;
a plurality of lenses each configured to control light emitted from a corresponding one of the plurality of light sources; and
a lens holder configured to hold the plurality of lenses,
wherein each of the plurality of lenses includes a flange,
wherein the lens holder includes:
a first lens holder having a plurality of lens insertion holes into which the plurality of lenses are inserted, respectively; and
a second lens holder having a plurality of openings through which light emitted from the plurality of lenses passes, respectively, and
wherein the flange of each of the plurality of lenses is sandwiched between the first lens holder and the second lens holder, thereby holding the plurality of lenses in the lens holder.

2. The lighting device according to claim 1, wherein each of the plurality of lenses is formed with a protrusion,
wherein a recess is formed at an edge of each of the plurality of lens insertion holes of the first lens holder, and
wherein the protrusion is fitted into the recess to prevent rotation of each of the plurality of lenses with respect to the first lens holder.

3. The lighting device according to claim 1, further comprising:
a substrate on which the plurality of light sources are mounted; and
a heat sink configured to support the substrate,
wherein the lens holder has a support configured to support each of the plurality of lenses on an optical axis of a corresponding one of the light sources.

4. The lighting device according to claim 3, wherein the heat sink is provided with a positioning pin that protrudes from the heat sink, and
wherein each of the substrate and the first lens holder is provided with a through hole through which the positioning pin is inserted.
